(19) United States
(12) Patent Application Publication
(10) Pub. No.: US 2022/0098940 A1
(43) Pub. Date: Mar. 31, 2022

(54) BOREHOLE DOSING APPARATUS, ARRANGEMENT AND METHOD

(71) Applicant: Reflex Instruments Asia Pacific Pty Ltd, Balcatta WA (AU)

(72) Inventor: Scott SHOLER, Balcatta WA (AU)

(73) Assignee: Reflex Instruments Asia Pacific Pty Ltd, Balcatta WA (AU)

(21) Appl. No.: 17/032,835

(22) Filed: Sep. 25, 2020

(51) Int. Cl. E21B 21/06; B01F 3/08; B01F 5/02

(52) U.S. Cl. CPC E21B 21/062; B01F 5/0256; B01F 3/0853

(57) ABSTRACT

A dosing apparatus for mixing additive fluid with a primary fluid to prepare a drilling fluid at a drilling site for use in a downhole drilling operation. The apparatus is of a size and weight that can be disposed on, in or in the vicinity of a fluid vehicle, drilling apparatus and/or drilling site. The dosing apparatus includes a dynamic mixer with at least a first primary fluid inlet, at least a first additive fluid inlet and at least a first drilling fluid outlet. The dynamic mixer is configured to receive and combine primary fluid and additive fluid to prepare drilling fluid. The dynamic mixer is configured or configurable to control the ratio of primary fluid to additive fluid in the prepared drilling fluid.

### TECHNICAL FIELD

This invention relates to borehole establishment and maintenance, in general, and more specifically to borehole dosing apparatus, a borehole dosing arrangement and an associated method for dosing a borehole. Agricultural uses of the dosing apparatus are also envisaged.

### BACKGROUND ART

The following discussion of the background art is intended to facilitate an understanding of the present embodiments only. The discussion is not an acknowledgement or admission that any of the material referred to is or was part of the common general knowledge as at the priority date of the application.

Boreholes are well-known in the art and generally collectively describe various types of holes drilled in the earth for various purposes, including the extraction of water, other liquids (such as petroleum) or gases (such as natural gas), geotechnical investigation, environmental site assessment, mineral exploration, drill and blast practices that may break up ore bodies, or the like.

In order to maintain a borehole, borehole stability technology has been developed and includes chemical as well as mechanical methods to maintain a stable borehole, both during and after drilling. One chemical method for borehole establishment and maintenance includes the use of drilling additives, which can range from simple water, simple chemical, oil or other simple excipient based formulations to complex formulations that are chemical, oil or other excipient based which are designed for specific site conditions to aid the drilling process. Adding drilling additives to a borehole as part of drilling is also referred to as ‘dosing’ the borehole.

Such drilling additives may perform the functions of carrying drill cuttings out of the hole, cleaning the drill bit, cooling and lubricating the bit, providing buoyancy to the drill string, controlling formation fluid pressures, preventing formation damage, and providing borehole support and chemical stabilisation.

For example, in a drill and blast application, a drilling additive may be formulated specifically to help prevent a wide range of down-hole problems including poor collaring, hole decay or sidewall instability, which in turn typically reduces the need for excess conditioning, expensive re-drills or a requirement for hole casing. Such a fluid may also provide a degree of lubrication to the hole and can improve the lifting capacity of an air stream for transporting drill cuttings out of the hole. A typical design characteristic for such a fluid can include deep penetration of the drill strata to bond friable, fragmented materials.

Applicant has identified a need in the art for enabling proper mixing and/or dosing of drilling additive with water on-site prior to and/or during drilling. Electricity is often unavailable on site, so achieving a predetermined mixing ratio and a homogenous mixture may be difficult as the powered apparatus may not be available on site.

Additionally, environmental conditions such as low or high temperatures play a role in proper mixing of drilling additive with water. The current embodiments were conceived with these shortcomings in mind.

### SUMMARY OF THE INVENTION

It is an object of the invention to provide a mixer and/or method for mixing additive fluid to a primary fluid for preparing drilling fluid.

The skilled addressee is to appreciate that reference herein to a “drilling additive” may broadly include reference to any fluid and/or associated additive that is useable to aid the drilling of boreholes into the earth. Examples of such drilling additives include air, air/water mixture, air/polymer mixtures, e.g. a foaming agent, water, water-based mud (WBM) e.g. bentonite, oil-based mud (OBM), synthetic-based fluid (SBM), simple chemicals like KCl, complex chemical formulations and/or the like. Drilling additives are typically used to control viscosity, improve borehole stability, improve shale stability, enhance drilling rate of penetration, cooling and lubricating of equipment, increased lubricity, enhanced shale inhibition, cleaning, etc.

In one aspect the present invention may be said to comprise a dosing apparatus for mixing additive fluid with a primary fluid to prepare a drilling fluid at a drilling site for use in a downhole drilling operation, the apparatus being of a size and weight that can be disposed on, in or in the vicinity of a fluid vehicle, drilling apparatus and/or drilling site, the dosing apparatus comprising: a dynamic mixer with at least a first primary fluid inlet, at least a first additive fluid inlet and at least a first drilling fluid outlet, the dynamic mixer configured to receive and combine primary fluid and additive fluid to prepare drilling fluid, wherein the dynamic mixer is configured or configurable to control the ratio of primary fluid to additive fluid in the prepared drilling fluid.

In one aspect the present invention may be said to comprise a dosing apparatus for mixing additive fluid with a primary fluid to prepare a drilling fluid at a drilling site for use in a downhole drilling operation, the apparatus being of a size and weight that can be handled by a human and/or be disposed on a primary fluid vehicle or drilling apparatus, the dosing apparatus comprising: a housing, a dynamic mixer with at least a first primary fluid inlet, at least a first additive fluid inlet and at least a first drilling fluid outlet, the dynamic mixer configured to receive and combine primary fluid and additive fluid to prepare drilling fluid, at least a first static mixer coupled to the dynamic mixer to receive and mix drilling fluid from the dynamic mixer, wherein the dynamic mixer is configured or configurable to control the ratio of primary fluid to additive fluid in the prepared drilling fluid.

Optionally the dynamic mixer comprises: a first venturi aspirator in fluid communication with the primary fluid inlet, additive fluid inlet and drilling fluid outlet, at least a first flow controller for controlling primary fluid flow and/or additive fluid flow to control the ratio of primary fluid to additive fluid.

Optionally the flow controller comprises at least one control valve.

Optionally the flow controller comprises at least one conduit restrictor.

Optionally the dosing apparatus further comprises a relief valve in communication with the primary fluid inlet upstream of the venturi aspirator.

Optionally the dynamic mixer comprises: a primary fluid flow path fluidly communicating the primary fluid inlet to the drilling fluid outlet via the Venturi aspirator in communication with the first additive fluid inlet, and a bypass fluid flow path fluidly communicating the primary fluid inlet to the drilling fluid outlet via the flow controller and bypassing the venturi aspirator.

Optionally the flow controller is a control valve that controls the aspiration of additive fluid to the primary fluid by control of the flow of fluid through the bypass fluid flow path.

Optionally the dynamic mixer comprises a second additive fluid inlet and a second flow controller and a second venturi aspirator, and wherein: a first mixer fluid flow path fluidly communicating the primary fluid inlet to the drilling fluid outlet via the first flow controller and first venturi aspirator in fluid communication with the first additive fluid inlet, a second mixer fluid flow path fluidly communicating the primary fluid inlet to the drilling fluid outlet via the second flow controller and second venturi aspirator in fluid communication with the second additive fluid inlet, wherein the first and second flow controllers control the aspiration of additive fluid to the primary fluid by control of flow of fluid through the respective first and second fluid flow paths.

Optionally the dosing apparatus further comprises a second drilling fluid outlet of the dynamic mixer and a second static mixer wherein the first static mixer is coupled to a first drilling fluid outlet of the first dynamic mixer and the second static mixer is coupled to a second drilling fluid outlet of the first dynamic mixer.

Optionally the dosing apparatus further comprises a second flow controller, and: a first flow controller path fluidly communicating the additive fluid inlet to the venturi aspirator via the first flow controller, a second flow controller path fluidly communicating the additive fluid inlet to the Venturi aspirator via the second flow controller, wherein the first and second flow controllers are configured and/or selectable differently to control the aspiration of additive fluid to the primary fluid by control of flow of fluid through the respective first and second fluid flow paths.

Optionally the first and/or second flow controller is a control valve.

Optionally the first and/or second flow controller is a conduit restrictor.

Also described is provided dosing apparatus comprising: a primary fluid inlet for operatively receiving a pressurised primary fluid; a Venturi aspirator arranged in-line with the fluid inlet and comprising: i) a drilling additive inlet for operatively aspirating a drilling additive; and ii) at least two conduits arranged in parallel upstream from the drilling additive inlet, each conduit having a user-configurable and/or controllable restrictor for individually controlling a rate of aspiration of drilling additive through that conduit; a static mixer arranged downstream from the Venturi aspirator to facilitate mixing of the primary fluid and aspirated drilling additive; and a mixture fluid outlet whereby the primary and drilling additive mixture is dischargeable, wherein a desired ratio of primary fluid to drilling additive is controllable via the Venturi aspirator.

In an embodiment, each conduit restrictor comprises a replaceable restrictor of a specific size, shape and/or structure which determines an aspiration rate of that conduit.

In an embodiment, each conduit restrictor comprises a controllable valve which determines an aspiration rate of that conduit.

In an embodiment, the Venturi aspirator includes a user-configurable and/or replaceable Venturi restrictor for controlling an aspiration rate of the aspirator.

In an embodiment, the primary fluid comprises water receivable via the primary fluid inlet, such as from a water truck, or the like.

In an embodiment, the primary inlet includes a flowmeter for measuring flow rate of the primary fluid.

In an embodiment, the primary fluid inlet includes an inlet pressure gauge for measuring primary fluid inlet pressure.

In an embodiment, the primary fluid inlet includes a pressure relief valve configured to control and/or limit a pressure of primary fluid supplied to the Venturi aspirator.

In an embodiment, the drilling additive inlet includes a flowmeter for measuring a flow rate of aspirated drilling additive.

In an embodiment, the drilling additive inlet includes a strainer for preventing aspiration of solid and/or semi-solid material above a certain size.

In an embodiment, the Venturi aspirator includes an aspirator pressure gauge for measuring a fluid pressure in the drilling additive inlet and/or conduit(s).

In an embodiment, the static mixer comprises a mixing chamber having interspaced therein a plurality of baffles configured to facilitate mixing of fluid therethrough.

In an embodiment, a wall of the mixing chamber is transparent or translucent to allow visual inspection of fluid mixing therein.

In an embodiment, mixture fluid outlet is plumbed to a mixture fluid reservoir whereby the primary and drilling additive mixture is dischargeable to a borehole.

In an embodiment, the mixture fluid outlet includes a one-way check valve to minimise backflow when a pressure of the primary fluid at the primary fluid inlet reduces below a predetermined value.

In an embodiment, the dosing apparatus includes a flow regulator, typically arranged before or after the static mixer, said flow regulator configured to regulate a flow of fluid through the apparatus.

In an embodiment, the dosing apparatus includes a controller and associated sensors for sensing fluid flowrates and/or pressures at the primary fluid inlet, drilling additive inlet and/or mixture fluid outlet, as well as actuators to automatically control the conduit restrictors, whereby the controller is configured to automatically control a ratio of primary and drilling additive mixture dischargeable via the mixture fluid outlet.

In an embodiment, the controller is configured to be remotely monitored and/or controlled via a suitable transceiver.

Also described is provided dosing apparatus comprising: a primary fluid inlet for operatively receiving a pressurised primary fluid; at least one dynamic mixer arranged in-line with the fluid inlet and comprising: i) a Venturi aspirator having a drilling additive inlet for operatively aspirating a drilling additive; and ii) a control valve plumbed in parallel with said aspirator, control of the valve controlling a rate of aspiration of the drilling additive due to diversion of primary fluid via the valve and/or aspirator; a static mixer arranged downstream from the dynamic mixer to facilitate mixing of the primary fluid and aspirated drilling additive; and a mixture fluid outlet whereby the primary and drilling additive mixture is dischargeable.

In an embodiment, the primary fluid comprises water receivable via the primary fluid inlet, such as from a water truck, or the like.

In an embodiment, the primary inlet includes a flowmeter for measuring flow rate of the primary fluid.

In an embodiment, the primary fluid inlet includes an inlet pressure gauge for measuring primary fluid inlet pressure.

In an embodiment, the primary fluid inlet includes a pressure relief valve configured to control and/or limit a pressure of primary fluid supplied to the dynamic mixer.

In an embodiment, the drilling additive inlet includes a flowmeter for measuring a flow rate of aspirated drilling additive.

In an embodiment, the aspirator is configurable to accommodate different ratios of aspirated drilling additive according to a pressure and/or flowrate of the primary fluid, and/or a viscosity of drilling additive.

In an embodiment, the aspirator is configurable by means of a user-configurable and/or replaceable Venturi orifice size, shape and/or structure.

In an embodiment, the aspirator is configurable by means of a user-configurable and/or replaceable restrictor for controlling drilling additive via the drilling additive inlet.

In an embodiment, the dynamic mixer includes an aspirator pressure gauge for measuring a fluid pressure in said dynamic mixer.

In an embodiment, the static mixer comprises a mixing chamber having interspaced therein a plurality of baffles configured to facilitate mixing of fluid therethrough.

In an embodiment, a wall of the mixing chamber is transparent or translucent to allow visual inspection of fluid mixing therein.

In an embodiment, mixture fluid outlet is plumbed to a mixture fluid reservoir whereby the primary and drilling additive mixture is dischargeable to a borehole.

In an embodiment, the mixture fluid outlet includes a one-way check valve to minimise backflow when a pressure of the primary fluid at the primary fluid inlet reduces below a predetermined value.

In an embodiment, the dosing apparatus includes a flow regulator, typically arranged before or after the static mixer, said flow regulator configured to regulate a flow of fluid through the apparatus.

In an embodiment, the dosing apparatus comprises two or more dynamic mixers arranged in parallel and/or series for aspirating separate first and second (or more) drilling additives.

In an embodiment, the dosing apparatus includes a controller and associated sensors for sensing fluid flowrates and/or pressures at the primary fluid inlet, drilling additive inlet and/or mixture fluid outlet, as well as at least one actuator to automatically control the control valve, whereby the controller is configured to automatically control a ratio of primary and drilling additive mixture dischargeable via the mixture fluid outlet.

Typically, the controller is configured to be remotely monitored and/or controlled via a suitable transceiver.

Also described is a dosing arrangement comprising: a primary fluid supply for operatively supplying pressurised primary fluid; dosing apparatus in accordance with the first or second aspects of the invention for receiving said primary fluid; and a mixture fluid reservoir for receiving the mixture of primary and drilling additives mixed by the dosing apparatus.

In an embodiment, the primary fluid supply comprises a water truck.

In an embodiment, the mixture fluid reservoir forms part of a drill rig for discharging the mixture of primary and drilling additives to a borehole.

Also described is provided a method for mixing a primary fluid and additive, such as for dosing a borehole, said method comprising the steps of: receiving a pressurised primary fluid via a primary fluid inlet; controlling a conduit restrictor of a Venturi aspirator which is arranged in-line with the fluid inlet and comprises: i) a drilling additive inlet for operatively aspirating a drilling additive; and ii) at least two conduits arranged in parallel upstream from the drilling additive inlet, each conduit having a user-configurable and controllable restrictor for individually controlling a rate of aspiration of drilling additive through that conduit; passing the primary fluid and aspirated drilling additive through a static mixer arranged downstream from the Venturi aspirator to facilitate mixture; and discharging, via a fluid outlet downstream from the static mixer, a mixture of the primary and drilling additives to a borehole.

In an embodiment, the method includes the step of calculating a desired mixture ratio of the primary and drilling additives.

In an embodiment, the step of calculating the desired mixture ratio is performed according to a rate of aspiration of the drilling additive into said aspirator in correlation with a rate of primary fluid supplied to the primary fluid inlet.

Typically, the step of controlling the conduit restrictor is performed to adjust the mixture ratio of the primary and drilling additives.

Also described is provided a method for mixing a primary fluid and additive, such as for dosing a borehole, said method comprising the steps of: receiving a pressurised primary fluid via a primary fluid inlet; controlling a control valve of at least one dynamic mixer which is arranged in-line with the fluid inlet and comprises: i) a Venturi aspirator having a drilling additive inlet for operatively aspirating a drilling additive; and ii) the control valve plumbed in parallel with said aspirator, control of the valve controlling a rate of aspiration of the drilling additive due to diversion of primary fluid via the valve and/or aspirator; passing the primary fluid and aspirated drilling additive through a static mixer arranged downstream from the dynamic mixer to facilitate mixture; and discharging, via a fluid outlet downstream from the static mixer, a mixture of the primary and drilling additives to a borehole.

In an embodiment, the method includes the step of calculating a desired mixture ratio of the primary and drilling additives.

In an embodiment, the step of calculating the desired mixture ratio is performed according to a rate of aspiration of the drilling additive into said aspirator in correlation with a rate of primary fluid supplied to the primary fluid inlet.

In an embodiment, the step of controlling the control valve is performed to adjust the mixture ratio of the primary and drilling additives.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The term “comprising” as used in this specification means “consisting at least in part of”. Related terms such as “comprise” and “comprised” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

The description will be made with reference to the accompanying drawings in which:

FIG. 1 is a general diagrammatic depiction of a borehole dosing apparatus.

FIG. 2 shows a drilling site where a borehole dosing apparatus is used.

FIGS. 3A-3D show diagrammatic and detailed versions of a first embodiment of the borehole dosing apparatus.

FIGS. 4A, 4B show diagrammatic and detailed versions of a second embodiment of the borehole dosing apparatus.

FIGS. 5A, 5B show diagrammatic and detailed versions of a third embodiment of the borehole dosing apparatus.

FIGS. 6A to 6E show diagrammatic and detailed versions of a fourth embodiment of the borehole dosing apparatus.

FIG. 7 shows examples of constrictor size to additive concentration in drilling fluid for various primary fluid flow rates.

FIG. 8 shows a comparison of the first embodiment to the fourth embodiment.

FIG. 9 shows a method of mixing using the apparatus.

### DETAILED DESCRIPTION OF EMBODIMENTS

### Overview and General Embodiment

Further features of the present embodiments are more fully described in the following description of several non-limiting embodiments thereof. This description is included solely for the purposes of exemplifying the present embodiments to the skilled addressee. It should not be understood as a restriction on the broad summary, disclosure or description of the embodiments as set out above. In the figures, incorporated to illustrate features of the example embodiment or embodiments, like reference numerals are used to identify like parts throughout.

The present applicants have developed drilling fluids that comprise a primary fluid (also called a “carrier fluid” or “dilutant fluid” or “base fluid”) and an additive. The primary fluid and additive are mixed (combined) and present in the composite resulting drilling fluid at relative proportions, for example at a desired concentration. That is, the additive is diluted to a concentration by the dilutant. Equivalently, it could be described as a ratio of relative proportions by volume, or a percentage by volume, or similar. So for example, the additive:dilutant ratio could be x:y; or alternatively the additive could be described as making up X % of the total drilling fluid by volume and the dilutant make up (100−X) % of the drilling fluid by volume. Overall, the manner in which the relative proportions of the additive and dilutant are specified is not essential to the embodiments, and any suitable manner could be used. Any reference to mix ratio, ratio, concentration etc. refer generally to some relative proportion of mixed components and should not been deemed limiting to a particular type of measure. The additive takes the form of an additive fluid that can be mixed with the primary fluid at the desired relative proportions (e.g. ratio, percentage or the like) to create a desired concentration of both components in the resultant drilling fluid. Typically, the primary fluid is water, which acts as a dilutant for the additive fluid.

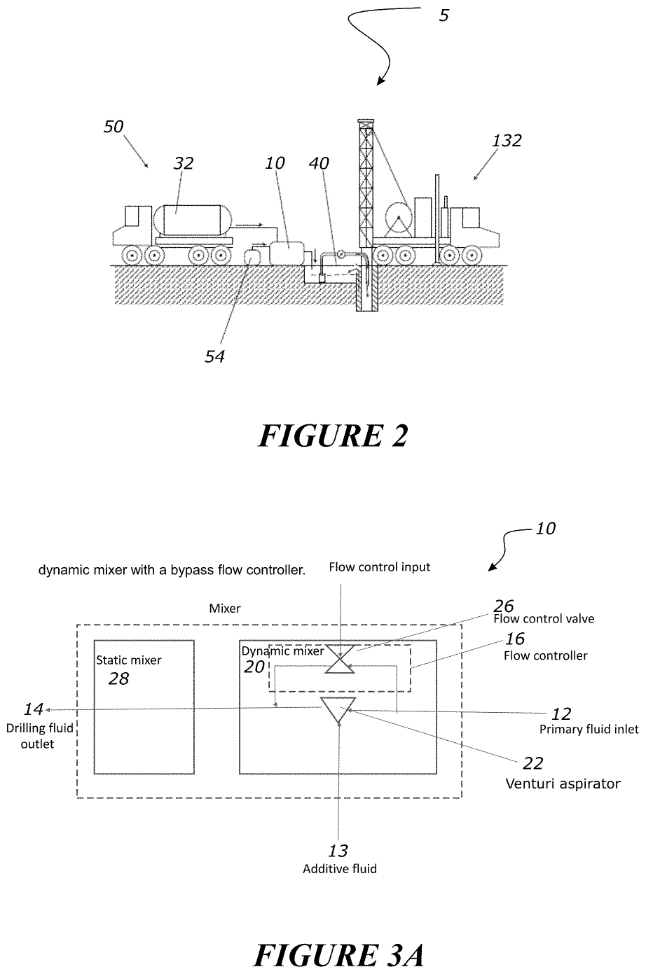

The drilling fluid is generally prepared on site at a drilling site—see generally 5, FIG. 2. As such, there needs to be a way to mix the primary fluid and additive fluid at the desired relative proportions to prepare the drilling fluid. Those preparing the drilling fluid on-site typically are not experts nor trained in the preparation of drilling fluid. Nor do they have time to prepare drilling fluids. For example, typically those on site are truck drivers and/or rig operators. Further, the conditions are harsh hot, dry, dusty and otherwise inhospitable. The operators need to spend as little time as possible preparing the mixture while being exposed to the elements. Thus there is a need to have an operation that is as simple as possible in such a harsh environment. As such, there needs to be a way to facilitate preparation of the drilling fluid from the correct mix of constituent components (that is, primary fluid and additive fluid) by people who have had relatively little or no training, expertise and/or time.

To achieve preparation of drilling fluid from primary fluid and their additives in this context, the present applicant has developed an apparatus to achieve the drilling fluid preparation by mixing the constituent components. This is referred to as a “borehole dosing apparatus”.

With reference now to the accompanying Figures, there is broadly shown an embodiment of a borehole dosing apparatus 10, as well as a borehole dosing arrangement 50 (see FIG. 2) comprising such apparatus 10. An associated method 60 of dosing a borehole is also described.

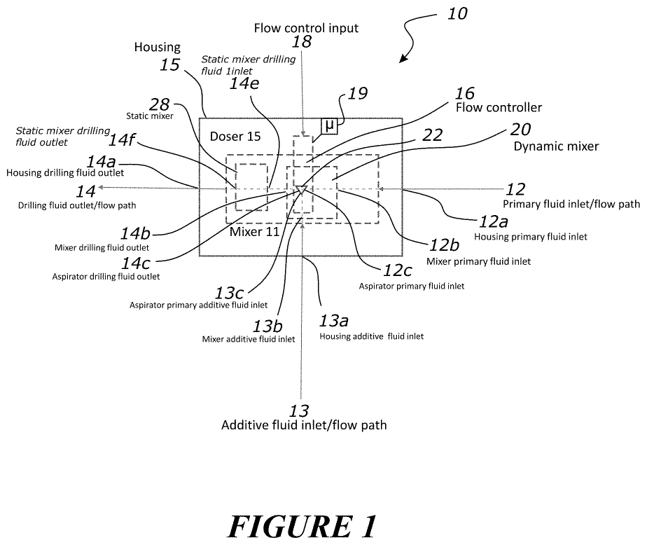

Referring to the general diagrammatic arrangements in FIG. 1, the borehole dosing apparatus 10 broadly comprises a housing 15 (although this is not essential) with a mixer 11, nominally shown in a dotted box. The mixer 11 will typically (although not necessarily) comprise a dynamic mixer 20 (preferably with one or more venturi aspirators 22) and a static mixer 28 as will described later. But other types of mixer 11 configuration might be possible, and not all the components might be in the same housing, but rather in separate housings, or no housing at all, or they may not be required at all. Note in this and other embodiments, the mixer 11 (comprising dynamic mixer 20 and static mixer 28) might comprise a number of components, but not have an actual housing or other “real” boundary—rather, it might be a nominal boundary. As such, the mixers 11, 20, 28 are shown in dotted lines and term “mixer” can refer to a functionality achieved by a combination of components within the nominal boundary. The dynamic mixer combines the additive fluid with the dilutant fluid.

The dynamic mixer 20 can have at least one venturi aspirator 22.

There is at least one housing primary fluid inlet 12a, at least one housing additive fluid inlet 13a and at least one housing drilling fluid outlet 14a to/from the housing 10. The dynamic mixer 20 can have at least one mixer primary fluid inlet 12b, at least one mixer additive fluid inlet 13b and at least one mixer drilling fluid outlet 14b. The venturi aspirator 22 can have at least one aspirator primary fluid inlet 12c, at least one aspirator additive fluid inlet 13c and at least one aspirator drilling fluid outlet 14c. The primary fluid inlet of the venturi aspirator 22 (“venturi aspirator primary fluid inlet” 12c) is in fluid communication with the primary fluid inlet of the dynamic mixer (“mixer primary fluid inlet” 12b) which is in fluid communication with the primary fluid inlet of the housing (“housing primary fluid inlet” 12a) through a primary fluid (inlet) flow path (generally 12) comprising conduits 12d (see other Figures) and/or other components.

Reference to “primary fluid inlet” 12 can generically be considered a reference to the primary fluid (inlet) flow path 12, and can refer to any of the housing primary fluid inlet 12a, the mixer primary fluid inlet 12b (where present), venturi aspirator primary fluid inlet 12c and/or any other the primary fluid flow path components e.g. 12d that make up the flow path 12, alone or in combination depending on context. Likewise, the additive fluid inlet of the venturi aspiratory 22 (“venturi aspirator additive fluid inlet” 13c) is in fluid communication with the additive fluid inlet of the dynamic mixer (mixer additive fluid inlet 13b) which is in fluid communication with the additive fluid inlet of the housing (housing additive fluid inlet 13a) through an additive fluid (inlet) flow path (generally 13) comprising conduits 13d and/or other components. Reference to “additive fluid inlet” 13 can generically be considered a reference to an additive fluid (inlet) flow path 13, and can refer to any of the housing additive fluid inlet 13a, the mixer additive fluid inlet 13b (where present), venturi restrictor additive fluid inlet 13c and/or the additive fluid flow path components 13d that make up the flow path 13, alone or in combination depending on context. The dynamic mixer receives additive fluid and primary fluid though the respective inlets 12, 13 and mixes the two at the desired relative proportions.

The apparatus has at least one flow controller 16. The dynamic mixer enables mixing of the additive fluid and primary fluid through one or more venturi restrictors and the one or more flow controllers 16. The configuration and operation of these allow for the mixing of the desired relative proportions of additive fluid and primary fluid.

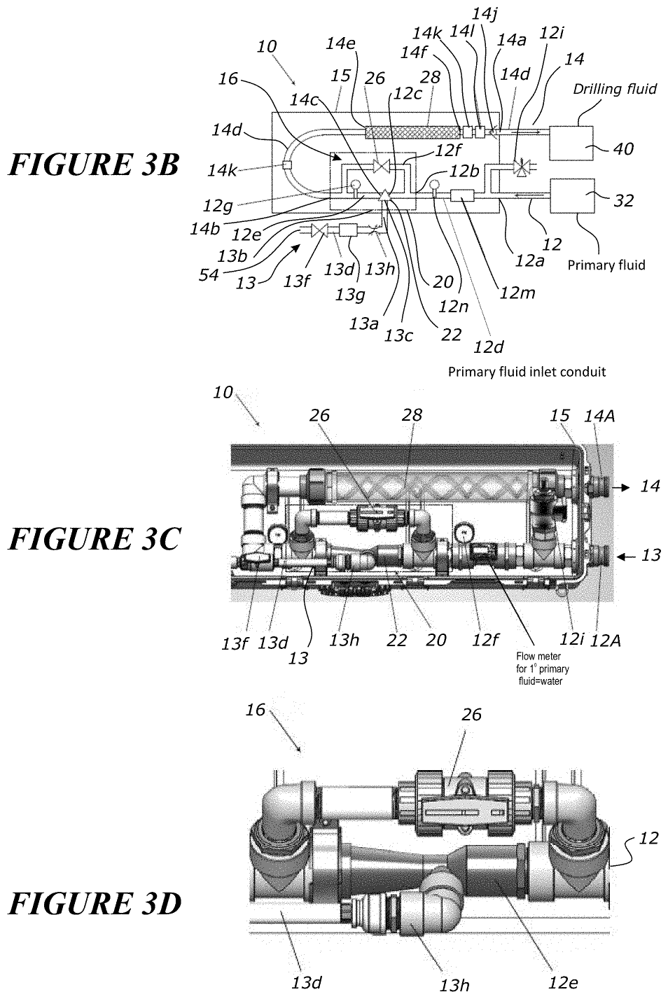

The venturi aspirator 22 has a venturi aspirator drilling fluid outlet 14c. The dynamic mixer 20 also has at least one mixer drilling fluid outlet 14b (mixer drilling fluid outlet) that fluidly communicates with the venturi aspirator fluid outlet 14c and at least one static mixer 28 via a static mixer drilling fluid inlet 14e via an input drilling fluid flow path 14 comprising conduits 14d (see e.g. FIG. 3B) and/or other components. At least one static mixer drilling fluid outlet 14f fluidly communicates with the housing drilling outlet 14a via an output drilling fluid flow path (generally 14) comprising conduits 14d and/or other components. The resultant drilling fluid is passed through the static mixer for further mixing, and is provided at an outlet 14a of the housing for dosing the borehole. Reference to “drilling fluid outlet” can generically be considered a reference to drilling fluid flow path 14, and can refer to any of the housing drilling fluid outlet 14a, the mixer drilling fluid outlet (static 14f or dynamic 14b), venturi restrictor drilling fluid outlet 14c (where present) and/or the drilling fluid flow path components 14d that make up the flow path 14 alone or in combination depending on context. The reference to the drilling fluid flow path 14 can also comprise the drilling fluid inlet 14e to the static mixer. The static mixer has baffles or similar to blend the fluid together to mix the combined additive and dilutant mixture to achieve a more homogenous mix.

There is a flow control input 18 into the mixer 11, which may control the static mixer and/or dynamic mixer, and in the case of the dynamic mixer having an aspirator, can control the aspirator.

Because a mixer can have a nominal boundary, the primary fluid inlet 12b, additive inlet 13b and drilling fluid outlet 14b are not necessarily physical components but rather are nominally at the mixer boundary and the terms are used for explanatory purposes. But, insofar as a mixer might have a physical boundary such as housing, these inlets and outlets can physically exist in that boundary.

Note, reference to a dynamic mixer might mean a mixer that can mix more than one additive fluid. In fact a dynamic mixer might comprise a plurality of dynamic mixers, which still can be referred to jointly (for simplicity) as a dynamic mixer. Therefore, reference to a dynamic mixer and/or additive in the singular does not necessarily preclude the reference to only a single mixing device and/or additive.

Likewise, reference to a static dynamic mixer might mean more than one mixer. In fact a static mixer might comprise a plurality of static mixers, which still can be referred to jointly (for simplicity) as a static mixer. Therefore, reference to a static mixer in the singular does not necessarily preclude the reference to only a single mixing device. In some embodiments, the static mixer might not exist, or might exist separate to the entire apparatus.

Likewise, reference to a flow controller might mean more than one flow controller. In fact a flow controller might comprise a plurality of flow controllers, which still can be referred to jointly (for simplicity) as a flow controller. Therefore, reference to a flow controller in the singular does not necessarily preclude the reference to only a single flow controller.

In general terms, the borehole doser apparatus is configured to mix additive fluid with the primary fluid to the required relative proportions. This can be by configuration of the flow controller, configuration of the venturi restrictor and/or configuration of other aspects of the doser apparatus. This might be a fixed configuration and/or adjustable configuration through adjustable and/or replaceable components.

The additive could be for example BORE-HOLE-STABILISER™ which is a viscous white liquid, with a pH between 7-9 with a specific gravity of 0.9-1.10 that helps prevent a wide range of down-hole problems in air drilling applications as it penetrates deep into the surrounding strata where it will bond friable, fragmented materials. In general standard conditions, BORE-HOLE-STABILISER™ can be mixed at a rate of 0.5-2% by volume. Although this concentration can be varied to provide appropriate bore hole stability. Thus typical concentration ranges for BORE-HOLE-STABILISER™ could be from 0.5-1.5%, or 0.8-1.5%, or 1-1.5%—again as dependent on conditions and purpose requirements.

Another alternative additive could be for example AMC LIQUI POL™ which is a rapid yielding, high molecular weight polymer in liquid form that provides viscosity to help improve core recovery, particularly in clays and shales and highly fractured formations.

In general standard conditions, AMC LIQUI POL™ can be mixed at 0.75-1.5 L/m3 of make-up fluid. Although these concentrations can be varied to provide appropriate viscosity for the purpose, such as for cuttings removal and/or efficient encapsulation of cuttings. Thus typical concentration ranges for AMC LIQUI POL™ could be from 0.05-0.8%, or 0.08-0.7%, or 0.09-0.6%, or 0.1-0.5%—again as dependent on conditions, purpose and viscosity requirements.

Another alternative additive could be AMC SHALEHIB ULTRA™ which is an amine based fluid additive that provides shale and clay inhibition in polymer based drilling fluids that reduces the potential for bit balling, torque and drag as well as other clay and shale related issues. The typical concentration ranges for AMC SHALEHIB ULTRA™ as recommended can be from 1-3.5%, however in practice dependent on the shale reactivity and the quantum of shale present at the drill site, this concentration range can be varied up to 6%. Thus typical concentration ranges can be from 1-6%, or 1.2-5.5%, or 1.5-5%, or from 1.7-4.5%, or from 2-4%, or from 2.2-3.8%, or from 2.5-3.5%.

Another fluid additive could be AMC LP 2000™ which is a rapidly yielding, high molecular weight polymer that provides viscosity that improves core recovery, particularly in clays and shales and highly fractured formations. Additionally it provides cuttings encapsulation plus borehole stabilisation. Dependent on the application, then the recommended concentration range can be varied from anywhere between 0.5-2%, although in practice dependent on the formation, this concentration range can be varied up to 3%. Thus typical concentration ranges can be from 0.5-3%, or from 0.5-2.5%, or from 0.8-2%, or from 1-2%.

Not shown in FIG. 1 but shown in other embodiments, the apparatus 10 optionally further comprises various components such as a primary fluid inlet flowmeter 12m in the primary fluid flow path 12 for measuring a flow rate of the primary fluid in the primary fluid flow path. In some embodiments, the primary fluid flow path may also optionally comprise a pressure gauge 12n for measuring primary fluid inlet pressure, or similar instruments for measuring characteristics of the pressurised primary fluid.

In an embodiment, the primary fluid inlet 12 may optionally comprise a pressure relief valve 12i which is configured to control and/or limit a pressure of primary fluid supplied to the dynamic mixer 20. For example, a water truck or cart 32 may only be able to supply water at a pressure higher than required for efficient operation of apparatus 10 and pressure relief valve 12i may be used to regulate and/or limit such fluid pressure to facilitate operation and/or minimise possible damage to the apparatus 10.

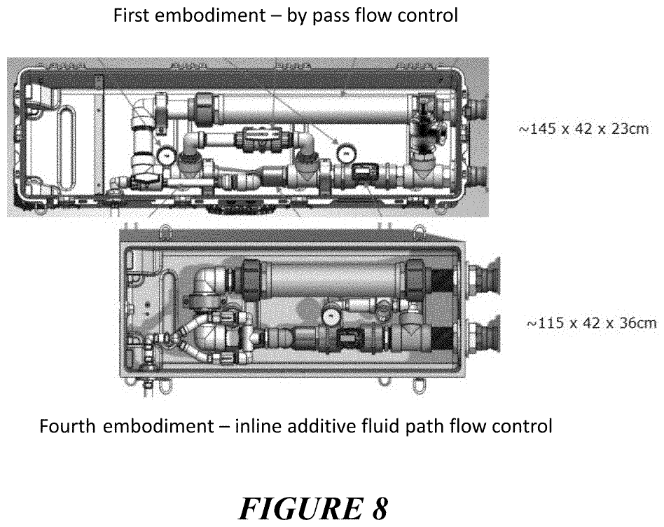

The borehole dosing apparatus 10 having a housing 15 facilitates transport and use thereof. The borehole dosing apparatus can be sized and dimensioned to allow transport as checked baggage on a commercial flight. The housing and apparatus as a whole also allows the dosing apparatus to be readily handled by a single person, or perhaps two people. It also allows the dosing apparatus to be disposed on and/or transported by typical drill site equipment and vehicles, such as trucks, drilling rigs and the like. A typical dosing apparatus could have dimensions of the following with reference to FIG. 8:

First embodiment: about 145 cm×about 42 cm×about 23 cm with weight of about 32 Kg.

Fourth embodiment: about 115 cm×about 42 cm×about 36 cm at a weight of about 22 Kg.

Other sizes are possible. For example, a smaller version could be about 80 cm×40 cm×30 cm. A larger version could be larger than the first embodiment, by e.g. 2-3 times, in one or more dimensions. More generally the apparatus could e.g. be between about 110 cm to about 450 cm×about 40 cm to about 150 cm×about 20 cm to about 110 cm.

These weights and dimensions should not be considered limiting. The apparatus can be scaled as required, but preferably so that it can be readily handled and/or disposed on a rig, truck, on site or the like.

Broadly, as shown in the drilling site 5 in FIG. 2, apparatus 10 forms part of a borehole dosing arrangement 50 which comprises a primary fluid supply 32 for operatively supplying pressurised primary fluid, and a mixture fluid reservoir 40 for receiving the mixture of primary and drilling additives mixed by the dosing apparatus 10. Typically, the mixture fluid reservoir 40 forms part of the drill rig 132 operations. The reservoir receives the mixture of primary and drilling additives that can be provided downhole to a borehole. The borehole dosing apparatus 10 is used in the following manner. The apparatus is on-site at the drilling site 5. For example, it might be on a water truck 32 that brings the primary fluid to site, or it might be on the drilling rig, or in some other location on-site e.g. in close proximity to the water tank as shown in this configuration.

Preferably, the borehole dosing apparatus 10 is preconfigured so that it mixes the required relative proportions of primary fluid to additive fluid to create the required prepared drilling fluid so that it is fit for the purpose it is intended for. The borehole dosing apparatus is configured to deliver the relevant proportions of the chosen additive for which its intended downhole purpose is. The primary fluid comes from a water reservoir 32, which may be disposed on site, or may be brought to site for example by a truck 32. The additive fluid also comes from an additive fluid reservoir 54, which may be disposed on site or may be brought to the site for example by a truck.

To prepare the drilling fluid, an operator connects a fluid line from the primary fluid reservoir 32 to the one or more primary fluid inlets 12 on the housing 15 of the borehole dosing apparatus 10 and connects a fluid line from the additive fluid reservoir 54 to the one or more additive fluid inlets in the housing. The borehole dosing apparatus is then operated. First, and insofar that it is required, the apparatus may be configured by the operator to provide the required mixing ratio. Although, in many cases this will be preconfigured off-site. Configuration can be through adjusting flow controllers (e.g. control valves), installing components (e.g. conduit restrictors and/or venturi restrictors), and the like. Then, the apparatus 10 is operated by way of opening various flow control valves on the apparatus itself and/or fluidly coupled to the fluid reservoirs. Some embodiments of the borehole dosing apparatus may be at least partially automated, and in such cases the automation is activated.

Once the apparatus 10 is operational, the primary fluid flows into the apparatus 10 and dynamic mixer 20 and additive fluid is drawn into the apparatus 10 and dynamic mixer 20 in the required flow rates/ratios. The resultant stage one drilling fluid is outputted from the dynamic mixer 20 and passed through to the static mixer 28. The output of the static mixer 28 is stage two drilling fluid and is provided to the drilling fluid outlet 14a of the housing.

The skilled addressee is to appreciate that the primary fluid generally comprises water, such as from a water truck 32, but other primary fluids are possible and within the scope of the present embodiments. Notably, it is to be appreciated that water trucks or water carts 32 typically include pumps and it is such a pump which enables operation of the apparatus 10, i.e. the apparatus 10 does not require an electricity supply. Similarly, where the apparatus 10 is used in an underground environment, such as a mine, elevation of a suitable primary fluid reservoir, such as a water tank on the surface, can provide the necessary head-pressure for operation of apparatus 10. In addition, an above ground reservoir could be provided instead, e.g. a water tower.

The above is described a broad form of the doser, which can take primary fluid, aspirate additive fluid into the primary fluid, mix the two fluids to a desired ratio as configured by the flow controller to prepare a drilling fluid. Various embodiments are now described, which show example configurations of the broad form. General features in common will be described with the same reference numerals as above.

### First Embodiment

A first embodiment will now be described with reference to FIGS. 3A, 3B, 3C, 3D. FIG. 3A shows the doser apparatus in diagrammatic/functional form, whereas FIGS. 3B, 3C and 3D show actual arrangements.

Referring to FIG. 3A, the first embodiment can be generally described as a doser apparatus 10 with a dynamic mixer 20 with a bypass flow controller 16. The dynamic mixer 20 comprises a venturi aspirator 22 for aspiration of additive fluid, a primary fluid inlet 12, additive fluid inlet 13, drilling fluid outlet 14, and a static mixer 28. Aspiration of additive fluid to the primary fluid through the venturi aspirator 22 is controlled by way of a flow control valve 26 in the bypass flow controller 16 that controls primary fluid flow.

Describing the embodiment in more detail now with reference to FIGS. 3B to 3D, the apparatus 10 comprises a housing 15 and at least one dynamic mixer 20 that has a mixer primary fluid inlet 12b that is arranged in-line with a housing fluid inlet 12a, via a conduit 12d to form the primary fluid flow path 12 as shown. The dynamic mixer 20 itself has a mixer primary fluid flow path 12e, which comprises a Venturi aspirator 22 having a venturi additive fluid inlet 13c (in fluid communication with a dynamic mixer additive fluid inlet 13b and housing additive fluid inlet 13a via a conduit 13d to form an additive fluid flow path 13—all generally referred to as the “additive flow fluid inlet” 13) for operatively aspirating an additive fluid (typically from an additive fluid reservoir 54, described below). The dynamic mixer 20 also has a secondary/bypass fluid flow path 12f, which comprises a flow controller 16 (such as a control valve 26) which is in parallel with the venturi aspirator 22/mixer primary fluid flow path 12e, as shown. Preferably, the flow controller has/comprises a control valve 26, which can be manually adjusted to increase or decrease primary fluid flow through the bypass fluid flow path 12f. In this manner, control of the valve 26 controls a rate of aspiration of the additive fluid by the venturi aspirator 22 due to diversion of primary fluid via the bypass fluid flow path 12f/flow controller 26 and/or venturi restrictor 22/mixer primary fluid flow path 12e.

The apparatus 10 might further comprise a flow meter 12m and/or pressure gauge 12n in the primary fluid flow path 12. The dynamic mixer 20 may also comprise an aspirator pressure gauge 12g in the mixer primary fluid flow path 12e for measuring a fluid pressure in the dynamic mixer 20, as required. Similarly, the additive fluid flow inlet 13 may optionally include a flowmeter 13g for measuring a flow rate of aspirated additive fluid, as well as an additive fluid inlet valve 13f, requirements depending, for opening/closing the additive fluid inlet 13. A venturi restrictor 13h can also be provided here, to assist with control of aspiration.

The aspirator 22 combines the additive fluid and primary fluid to create a stage one drilling fluid. This is provided to the aspirator outlet 14c and then dynamic mixer drilling fluid outlet 14b. As is generally known in the art, an aspirator is a type of ejector-jet pump, which produces vacuum by means of the Venturi effect. In an aspirator, fluid (liquid or gaseous) flows through a tube that first narrows and then expands in cross-sectional area. When the tube narrows, the fluid pressure decreases. In this narrow area the fluid velocity must increase to conserve mass continuity. Where the tube narrows, a vacuum is drawn because of the Venturi effect. In the manner described, an amount of drilling additive can be aspirated depending on the flowrate of primary fluid passed through the aspirator 22, which is in turn regulated by the control valve 26.

Therefore, by configuration of the control valve, the required ratio of additive and primary fluid in the drilling fluid can be controlled. In addition, the aspirator 22 may be configurable to accommodate relative proportions of aspirated additive fluid according to a pressure and/or flowrate of the primary fluid, and/or a viscosity of additive fluid. This may take the form of user-configurable and/or replaceable Venturi orifice size, shape and/or structure. For example, the aspirator 22 may be configured to receive user-selectable Venturi orifices, each shaped and/or dimensioned to provide different aspiration characteristics, i.e. higher or lower aspiration rates, ability to aspirate more or less viscous drilling additives, etc.

Similarly, in another embodiment, the aspirator 22 may also be configurable to accommodate different ratios of aspirated additive fluid by means of a user-configurable and/or replaceable restrictor 13h for controlling drilling additive via the additive fluid inlet 13a. For example, the venturi restrictor 13h may comprise a suitable flow impediment placed in the additive fluid inlet 13a and configured to affect the aspirator's aspiration characteristics, i.e. higher or lower aspiration rates, ability to aspirate more or less viscous drilling additives, etc.

In this manner, the dynamic mixer 20 can be configured by the flow controller and/or aspirator to provide additional ways in which aspiration can be regulated or controlled over and above the control valve 26 to get the required mix ratio. Manipulation of the flow controller, the aspirator's Venturi orifice size, along with use of the restrictor 13h in the drilling additive inlet can be used to control and regulate drilling additive aspiration and eventual mixing with the primary fluid.

Following the dynamic mixer 20, apparatus 10 also includes a static mixer 28 which is generally arranged downstream in a drilling fluid outlet/flow path 14 (comprising a dynamic mixer drilling fluid outlet 14b, drilling fluid outlet conduit 14d, static mixer drilling fluid inlet 14e) from the dynamic mixer 20 to facilitate mixing of the primary fluid and aspirated additive fluid. The static mixer receives the stage one drilling fluid and mixes it further to create the stage two drilling fluid which is provided to the static mixer drilling fluid outlet 14c. Typically, the static mixer 28 comprises a mixing chamber having interspaced therein a plurality of baffles configured to facilitate mixing of fluid therethrough. In an embodiment, a wall of the mixing chamber is transparent or translucent to allow visual inspection of fluid mixing therein which may assist an operator in ascertaining proper mixing of the primary and additive fluids.

In an embodiment, the dosing apparatus 10 drilling fluid flow path 14 may also include a flow regulator 14k, which is typically arranged before or after the static mixer 28, with said flow regulator 14k configured to regulate a flow of fluid through the apparatus 10. As is known in the art, such a flow regulator typically regulates a pressure of fluid, e.g. inducing a back-pressure to regulate pressure, or the like.

Apparatus 10 includes a drilling fluid outlet 14a in the drilling fluid flow path 14, whereby the mixed primary and additive fluid mixture (that is the stage 2 drilling fluid) is dischargeable to a borehole.

In an embodiment, drilling fluid outlet 14 is arranged in fluid communication with a mixture fluid reservoir 40 (see FIG. 2) whereby the primary and additive fluid mixture is dischargeable to a borehole. In addition, the drilling fluid outlet 14a may optionally include a one-way check valve 14j to minimise backflow when a pressure of the primary fluid at the primary fluid inlet 12 reduces below a predetermined value.

Configuration and use of the first embodiment will now be described. As shown in FIG. 2, a water cart arrives on site full of water to provide the primary fluid. A pump onboard the water cart pumps water into the apparatus 10. The water travels through the primary fluid path 12 and into the dynamic mixer 20 and can split into two paths—the mixer primary fluid flow path 12e and the bypass fluid flow path 12f. By control of valve 26, the flow rate of primary fluid through the bypass fluid flow path 12f controls the relative proportions of additive fluid and primary fluid in the resultant drilling fluid. This works as follows.

The additive fluid (chemical) flow rate into the aspirator 22 can be calculated as:

$$Chemical flowrate = \frac{Volume of Chemical}{Time Taken to draw chemical into the system}$$

Then the dosage rate can be calculated:

$$Dosage rate = \frac{Water flow rate}{Chemical Flow rate}$$

The operator compares the water flow rate (using the Water flowmeter 12m on the inlet side) against additive fluid (chemical) flowrates 13g (calculated chemical flowrate) and can adjust the mixer to achieve the desired relative proportions e.g. 1:100 chemical to water ratio. Two mechanisms have been designed to adjust the mix-ratio. The first mechanism is a physical orifice restrictor 13h on the additive suction line which limits the rate of flow of additive fluid into the system. The other mechanism is the by-pass valve 26. The additive fluid flow rate is controlled by altering the pressure differential across the aspirator 22.

For example, when the by-pass valve 26 is set to closed, the primary fluid is restricted to only flow through the aspirators 22 small constriction. As it is pushing a larger volume of fluid through a small cross-section, Pᵢₙₗₑₜ will be higher than Pₒᵤₜₗₑₜ, creating a low pressure area in the injection zone. In other words, the higher the pressure differential, the stronger the vacuum is in the additive fluid suction line—i.e.: higher chemical flow rate.

In scenario two, when the by-pass valve is set to OPEN, a ‘path of least resistance’ is created. Most of the fluid being pumped into the system will travel through that by-pass rather than through the Venturi constriction. The diverted fluid will begin equalizing the pressure on the output side of the aspirator. So, if pumping pressure Pᵢₙₗₑₜ remains the same, Pₒᵤₜₗₑₜ will be higher. Since vacuum in the chemical suction line is dependent on a pressure differential across the aspirator and the differential (Pᵢₙₗₑₜ−Pₒᵤₜₗₑₜ) is now getting smaller, the vacuum in the chemical suction line is getting weaker—ie: lower chemical flow rate.

If the by-pass valve doesn't give the operator the chemical flow rate required to achieve the e.g. 1:100 mix ratio, the operator must use a different size orifice restrictor (a kit will contain a range of different sizes—i.e.: 2.5, 3.0, 3.5 & 4.0 mm) and a manual or calculator that will help with selection When in use, in one example, an operator records the time taken for a specific volume of a drilling additive to be aspirated in order to calculate the drilling additive flowrate or “aspiration rate” as the volume of aspirated drilling additive divided by the period of time taken for such aspiration to occur. A “dosage rate” can then be calculated as the primary fluid flowrate divided by the drilling additive flowrate or “aspiration rate”. In such a manner, the operator can adjust the apparatus 10 to achieve a desired mixture ratio of primary and drilling additives, e.g. 1-part drilling additive to 100-parts water, or the like.

However, other embodiments may automate this process via suitable automation, such as described below.

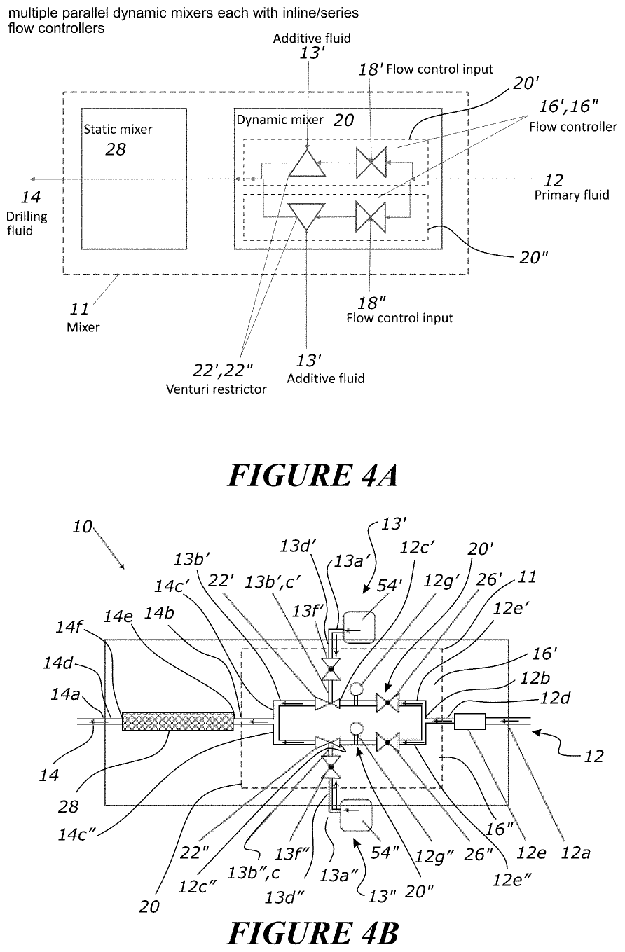

A second embodiment will now be described with reference to FIG. 4A, 4B. This is similar to the first and other embodiments with:
a primary fluid inlet/flow path (comprising housing primary fluid inlet, mixer primary fluid inlet, venturi aspiratory primary fluid inlet, primary fluid inlet flow path),
additive fluid inlet/flow path (comprising housing additive fluid inlet, mixer additive fluid inlet, venturi aspiratory additive fluid inlet, additive fluid inlet flow path), and
drilling fluid outlet/flow path (comprising housing drilling fluid outlet, mixer drilling fluid outlet (static or dynamic), venturi aspiratory drilling fluid outlet and/or the drilling fluid flow path) except with configuration differences as described here.

### Second Embodiment

With reference to FIGS. 4A, 4B the second embodiment can be generally described as a doser apparatus with multiple parallel dynamic mixers each with inline/series flow controllers. Referring to FIG. 4A, the second embodiment of apparatus 10 comprises two dynamic mixers 20′, 20″ (which jointly can be referred to as a dynamic mixer 20) generally arranged in parallel (a series arrangement also possible) for aspirating separate first and second (or more) additive fluids, via first and second additive fluid inlets 13′/13″ (which can be jointly referred to as an additive fluid inlet 13) and first and second aspirators 22′/22″ (which can be jointly referred to as a venturi aspirator 22) by first and second flow controllers 16′, 16″ (which can be jointly referred to as a flow controller)

The apparatus will now be described in more detail with reference to FIG. 4B. There is a housing 10 with a primary fluid flow path 12, comprising a housing primary fluid inlet 12a, a conduit 12d, and a mixer primary fluid inlet 12b that leads into a dynamic mixer 20. The mixer primary fluid inlet 12b splits into a first dynamic mixer 20′ and a second dynamic mixer 20″. The first and second mixers 20′, 20″ have respective first and second flow paths 12e′, 12e″, each flow path comprising a respective first and second flow controller 16′, 16″, e.g. in the form of e.g. a control valve 26′, 26″ and a respective first and second venturi aspiratory 22′, 22′ with a respective aspirator primary fluid inlet 12c′, 12c″. The first and second aspirator 22′, 22″ has a respective first and second additive fluid inlet/flow path 13 (13′, 13″), each comprising a housing additive fluid inlet 13a′, 13a″ aspirator additive fluid inlet 13c′, 13c″, dynamic mixer additive fluid inlet 13b′, 13b″ and additive fluid inlet valve 13f′, 13f″ all fluidly coupled by a conduit 13d′, 13d″. Each additive fluid inlet 13′, 13″ connects to a respective additive fluid reservoir 54′,54″. Each aspirator 22′, 22″ and dynamic mixer 20′, 20″ has a drilling fluid outlet 14c′, 14c″, that join to form a dynamic mixer drilling fluid outlet 14b, which may join within the mixer 22 or outside of it. The mixer provides stage 1 drilling fluid to the dynamic mixer drilling fluid outlet 14b. The drilling fluid outlet 14b couples to a drilling fluid inlet 14e of the static mixer 28, and the static mixer has a drilling fluid outlet 14f that couples to a drilling fluid outlet 14a of the housing 10 via a conduit 14d to provide the drilling fluid outlet/fluid flow path 14.

In other embodiments, more than two dynamic mixers 20 may also be included, requirements depending, each with a primary fluid inlet 12, additive fluid inlet 13, flow controller 16, aspirator 22 and drilling fluid outlet 14.

Each control valve 26′ and 26″, as shown, can complementarily control respective aspiration rates by aspirators 22′ and 22″ from a single primary fluid inlet 14. For example, if both control valves 26′ and 26″ are fully open, aspiration rates by aspirators 22′ and 22″ [may be substantially equal (disregarding differences in fluid characteristics). However, if control valve 26′ is more closed than control valve 26″, aspirator 22″ will typically have a higher aspiration rate than aspirator 22′, etc. Additional control of respective aspiration rates for each aspirator 22′ and 22″ may also be possible via inlet valves 13f′ and 13f″.

### Third Embodiment

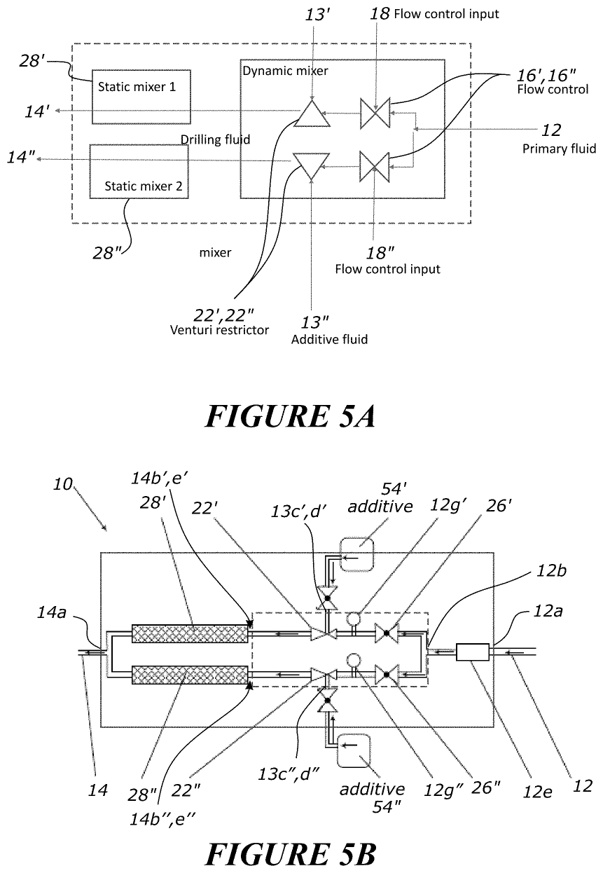

A third embodiment will now be described with reference to FIG. 5A, 5B. This is similar to the second embodiment, except there are two static mixers. Therefore, the third embodiment can be generally described as a doser apparatus with multiple parallel dynamic mixers with inline/series flow controllers and multiple static mixers.

Referring to FIGS. 5A, 5B, instead of the drilling fluid outlet of each dynamic mixer being joined, rather the drilling fluid outlet 14b′, 14b″ of each dynamic mixer is fluidly communicated with respective drilling fluid inlet 14e′, 14e″ of a respective first and second static mixer 28′ and 28″, as shown, to ensure homogenous mixing, with the respective outlets combined into a single drilling fluid outlet 14, as shown.

### Fourth Embodiment

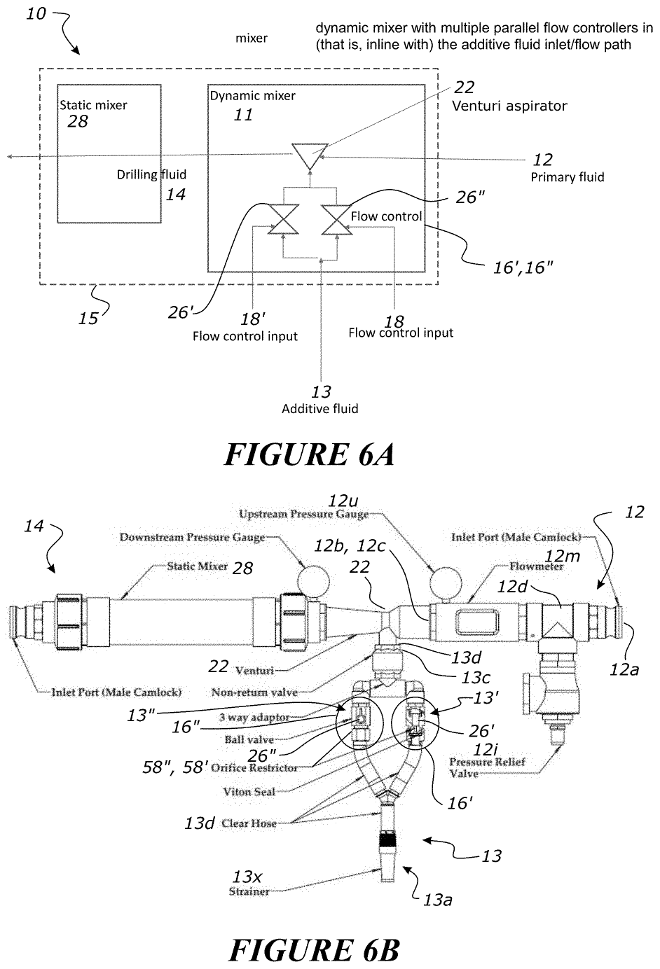

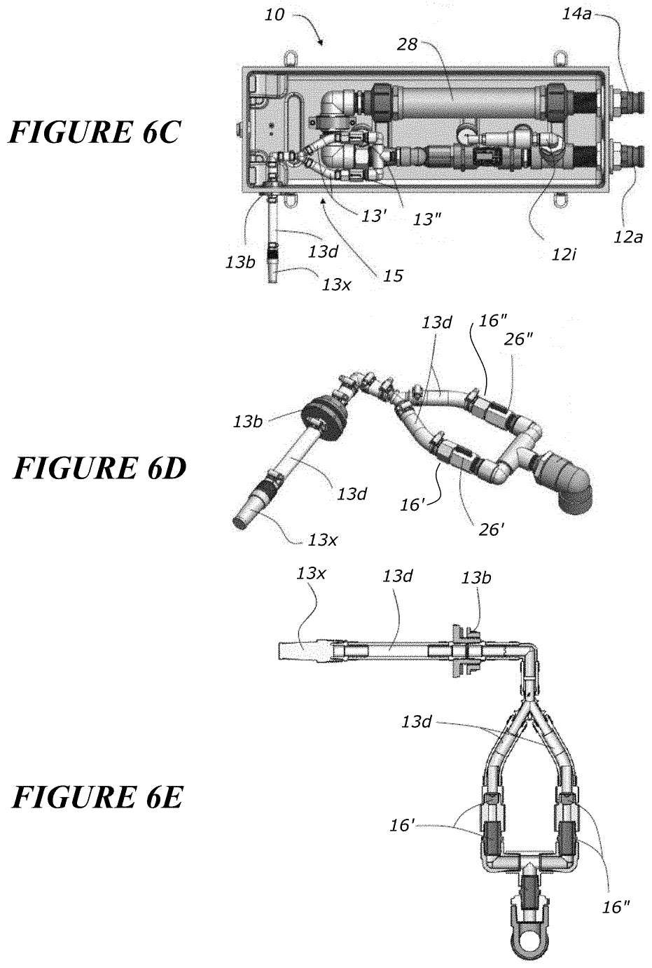

A fourth embodiment will now be described with reference to FIGS. 6 to 9. This is similar to the first and other embodiments with:
a primary fluid inlet/flow path (comprising housing primary fluid inlet, mixer primary fluid inlet, venturi aspiratory primary fluid inlet and primary fluid inlet flow path),
additive fluid inlet/flow path (comprising housing additive fluid inlet, mixer additive fluid inlet, venturi aspiratory additive fluid inlet, additive fluid inlet flow path), and
drilling fluid outlet/flow path (comprising housing drilling fluid outlet, the mixer drilling fluid outlet (static or dynamic), venturi aspiratory drilling fluid outlet and/or the drilling fluid flow path) except with configuration differences as described here.

With reference to FIGS. 6A to 6E, the fourth embodiment can be generally described as a doser apparatus 10 with a dynamic mixer with multiple parallel flow controllers in (that is, in line with) the additive fluid inlet/flow path. This differs from previous embodiments where the flow controllers are in the primary fluid flow path and/or bypass that passage.

Referring to the diagrammatic representation in FIG. 6A, an embodiment generally comprises the primary fluid inlet 12 for operatively receiving a pressurised primary fluid, a Venturi aspirator 22 in fluid communication with the primary fluid inlet 12, as shown, and the venturi aspirator is in fluid communication with an additive fluid inlet 13. The additive fluid inlet 13 comprises two or more parallel additive flow paths 13′, 13″ each providing a flow controller 16′, 16″ upstream of the venturi aspirator 22. A static mixer 28 arranged downstream from the Venturi aspirator 22 to facilitate mixing of the stage 1 drilling fluid comprising the primary fluid and additive fluid. Apparatus 10 also includes a stage 2 drilling fluid outlet 14 whereby the second stage drilling fluid after it is mixed by the static mixer is dischargeable.

The fourth embodiment will now be described in more detail with reference to FIGS. 6B to 6E. A primary fluid flow path 12 is provided, comprising a housing primary fluid inlet 12a, conduit 12d, optional primary fluid flowmeter 12m, optional primary fluid pressure gauge 12u leading to a dynamic mixer 11 with venturi aspirator 22 and venturi restrictor primary fluid inlet 12b, 12c all in fluid communication. The primary fluid flow path 12 also optionally comprises a pressure relief valve 12i. A drilling fluid outlet path 14 is provided, comprising a drilling fluid flow (first stage) dynamic mixer drilling fluid outlet, an optional drilling fluid pressure gauge, a static mixer with drilling fluid inlet and drilling fluid outlet that leads to a (second stage) housing drilling fluid outlet.

An additive fluid flow path 13 is provided comprising a housing additive fluid inlet 13a, conduit 13d, mixer inlet 13b and venturi aspirator additive fluid inlet 13c and optionally: a strainer, and a clear window (which could also be conduit 13d) all in fluid communication. These components might be outside or inside the doser housing 15 and/or inside or outside the dynamic mixer housing 20, and the placement shown should not be limiting. The additive flow path 13 also comprises a flow controller 16 comprising at least two flow control conduits/sub-paths 13′, 13″ arranged in parallel downstream of the housing additive fluid inlet 13a and upstream of the venturi aspirator additive fluid inlet 13c. Each flow control conduit 13′, 13″ provides an additive fluid sub-path and each is configured with a flow controller 16′, 16″, and provides fixed and/or adjustable configurations for controlling additive fluid flow and therefore mixing the relative proportions of the additive fluid and primary fluid. Each flow controller 16′, 16″ can provide a different configurations that provide different mixing ratios to enable an operator to quickly and easily switch between different mixing ratios, without reconfiguration of each flow controller. Preferably, each conduit 13′, 13″/flow controller 16′, 16″ has removable flow conduit (orifice) constrictors 58′, 58″ to provide a fixed configuration flow rate through the respective path; and an adjustable control valve 26′, 26″ with e.g. a 3-way ball valve adaptor to enable an operator to open and close the respective additive fluid sub-path 13′, 13″. The size of the constrictors 58′, 58″ sets the mix concentration of the mixer. Therefore, by selecting and installing constrictors of a particular size, the desired mix concentration can be achieved. Each flow sub-path 13′, 13″ can provide a pre-configured mix concentration, which can be selected by opening and closing the required sub-paths using the control valves 26′ 26″. The flow paths combine again at a non-return valve and connect into the venturi aspirator 22 at point 13c.

A user-configurable and/or controllable conduit restrictor 58′, 58″ is provided for individually controlling a rate of aspiration of drilling additive through that conduit 13′, 13″—that is, each conduit restrictor 58′, 58″ enables individual control over its conduit 13′, 13″. In this manner, a desired relative proportion of primary fluid to drilling additive is controllable via the Venturi aspirator, i.e. individual control/design of each conduit restrictor 58′, 58″ and flow control through each path 13′, 13″. The skilled addressee is to appreciate that each conduit restrictor 58′, 58″ may comprises a replaceable restrictor of a desired size, shape and/or structure which determines an aspiration rate of that conduit, and/or a controllable valve which determines an aspiration rate of that conduit.

For example, and without limitation, in this embodiment, each conduit/sub-path 13′, 13″ (of which there may be more than two of, e.g. three or more) is individually controllable via conduit restrictors 58′, 58″, or other configured flow impediments and/or controllable valves, in order to control and manage an aspiration rate of the Venturi aspirator 22. For example, one conduit 13′ may include a 4.0 mm diameter flow restrictor and a valve, with the other conduit 13″ having a 5.5 mm diameter flow restrictor and a valve, or the like. Each conduit 13′, 13″ can be suitably controlled according to requirements, such as outside temperature which affects viscosity of a drilling additive, or the like. It will be appreciated that more than two sub-paths could be provided, each configured or configurable to provide alternative mix ratios.

As each sub-path 13′, 13″ can provide a different pre-configured mix concentration, then it is possible to select a different concentration by selecting the path using the valves 26′, 26″. In one option, the apparatus is configured to provide different mix proportions, the first being 1% as a proportion of the entire drilling fluid volume, and the second being 1.5% as a proportion of the entire drilling fluid volume. These are just examples, and should not be considered limiting. The apparatus is configured to provide the desired relative proportions of primary fluid and additive fluid in the resulting drilling fluid. For the purposes of this explanation, the reference will be to a percentage concentration, that is the percentage of additive fluid as a volume to the overall drilling fluid volume, and the percentage of primary fluid as a volume to the overall drilling fluid volume.

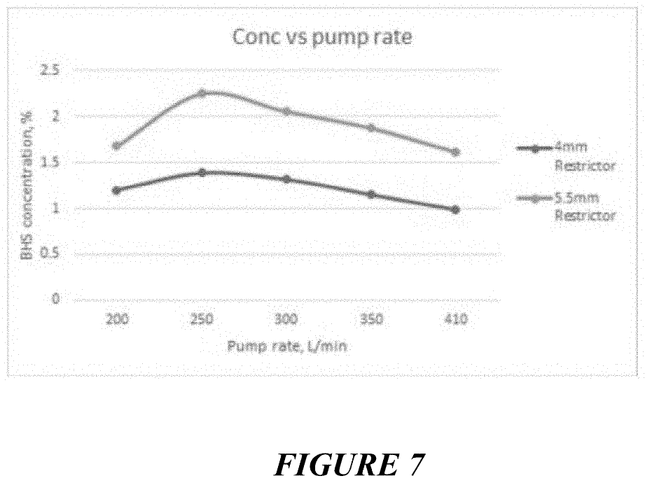

FIG. 7 shows an example of what is achieved by different sized restrictors, by way of example 4 mm restrictor and 5.5 mm restrictor (this is the diameter of the aperture). This type of graph can be used to design/configure the apparatus 10. The graph in FIG. 7 shows how the concentration of the additive fluid as a volume percentage of the overall drilling fluid (see y axis, BHS (borehole stabiliser) concentration changes based on the size of the restrictor and the flow rate of primary fluid through the system. By installing a restrictor of a particular size, and by controlling the flow rate of primary fluid from the fluid source (e.g. water truck) by valve and/or flow meter, the desired mix concentration can be achieved. Different restrictors with different size apertures will have a different flow rate/concentration profile, and so the restrictor size can be selected based on the flow rate of primary fluid through the system and the desired additive fluid concentration of the additive fluid in the resultant drill in fluid. The primary fluid flow rate will usually be fixed, based on the tap/valve size of the water source. As the primary fluid flow rate increases, the venturi has more suction, and sucks more additive in, thus increasing the BHS concentration (additive fluid) concentration in overall drilling fluid. As the flow rate increases, the BHS concentration (additive fluid) peaks and starts to taper off. This is because the suction peaks, and the flow rate of BHS aspirated stays the same, while the primary fluid flow rate increases, thus reducing the overall concentration of BHS (additive fluid).

Once the restrictor size has been decided upon, it can be manufactured, bought or otherwise prepared. For example, a blank plug is obtained then drilled out to the desired bore/aperture size e.g. 4 mm, or 3 mm, or 5.5 mm. With the a 4 mm and 5.5 mm aperture, you can see what percentage that gives as per the water flow pump rate in FIG. 7.

The ambient temperature can alter the percentage mix that is achieved for a particular flow rate and aperture size. So temperature, is likely to have a dosage rate impact (that is, impact on the flow rate at which the additive fluid is added, and therefore the relative proportions of additive fluid and primary fluid) to the drilling fluid. This is because the additive fluid may be more or less viscous based on temperature. For example, the additive fluid may be more viscous in the morning when the temperature is cooler, and less viscous later in the day when the temperature is hotter—this will affect the percentage of additive fluid that ends up in the final drilling fluid for a particular flow rate of primary fluid. As the temperature increases or decreases, the graph lines will raise and lower. The two sub-paths 13′, 13″ enable constrictors of different sizes and therefore different additive fluid dosage rates to compensate for different primary fluid flow rates due to different temperatures. For example, in the morning the operator may start with the sub-path 13′ that has the larger sized restrictor to allow more additive fluid in as it will be more viscous and flow slower, and as the temperature increases—the operator may switch over to the second sub-path 13″ with the smaller sized restrictor to allow less additive fluid in as it will be less viscous and flow faster.

For example, the first sub-path 13′ can have a conduit constrictor of 4 mm which provides a mix concentration of for a particular flow rate as shown in FIG. 7, while the second sub-path 13″ have a conduit constrictor of 5.5 mm which provides a mix concentration as per FIG. 7. When temperatures are lower (e.g. in the morning) the additive is more viscous so the bigger constrictor path 13″ is chosen as to ensure the required additive fluid volume is added to achieve a desired mix concentration. When temperatures are higher (e.g. later in day) the additive is less viscous so a smaller aperture 4 mm to ensure the required additive fluid volume is added to achieve a mix concentration.

In embodiments the apparatus 10 can be configured, off site, onsite and/or in real time by installing constrictors of the desired size and/or otherwise configuring flow rates to achieve the required relative proportions of additive and primary fluid in the resultant drilling fluid. This can be through control of introduction (e.g. through flow rates) of primary and additive fluids into/by the mixer. Having preconfigured paths 13′, 13″ enables a switch without an unskilled operator and/or operator with limited time having to reconfigure the doser—rather they can simply switch between ratio options.

In one embodiment, the Venturi aspirator 22 may also include a user-configurable and/or replaceable Venturi restrictor 55 for controlling an aspiration rate of the overall aspirator. The drilling additive inlet 24 also includes a strainer for preventing aspiration of solid and/or semi-solid material above a certain size, as well as a housing gland for passing the drilling additive inlet 24 through the housing 12.

Referring to FIG. 8, the fourth embodiment, in addition to providing multiple pre-configured ratio selection options, is also smaller and lighter in size than the first embodiment. This is because by dispensing with the bypass flow controller path, two fluid T-Junctions can be dispensed with. This reduces the overall length of the apparatus because of the absence of the T-junctions by about 30 cm×13 cm, and also removes weight, approximately 33 kgs to 23 kgs

The skilled addressee is also to appreciate that, in a further embodiment, the dosing apparatus 10 according to any embodiment herein, may be automated by comprise a suitable controller 19 and associated sensors for sensing fluid flowrates and/or pressures at the primary fluid inlet 14, additive fluid inlet 13 and/or drilling fluid outlet 14, as well as at least one actuator to automatically control the control valve 26 or conduit restrictor(s) 58. In such a manner, the controller can be configured to automatically control a ratio of primary and additive fluid dischargeable via the drilling fluid outlet 14. As is known in the art of process automation, the controller may also be configured to be remotely monitored and/or controlled via a suitable transceiver to allow remote monitoring and control of dosing apparatus 10. Additionally, the apparatus 10 may comprise at least one refractometer 141 (see e.g. FIG. 3B but it could be in any embodiment), or similar sensor, whereby the controller is able to determine proper mixture of the primary fluid and additive fluid. In a typical example, apparatus 10 may include two refractometers 4k, as shown, so that ‘before’ and ‘after’ measurements of the refraction of fluid through apparatus 10 can be used to determine proper mixing of primary fluid and additive, or the like.

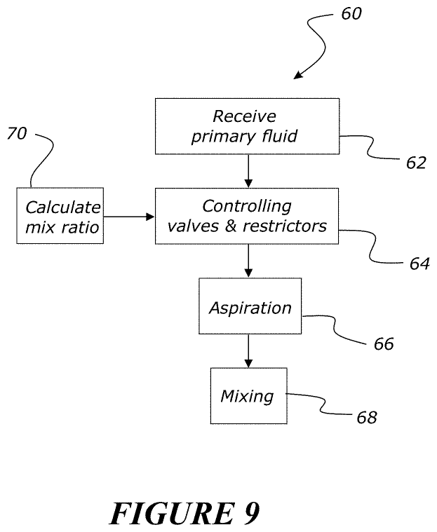

With reference to FIG. 9, the present embodiments also extend to a method 60 for mixing primary fluid with at least one additive, such as for dosing a borehole, according to any of the embodiments. Such a method 60 generally comprises the steps of receiving 62 a pressurised primary fluid via primary fluid inlet 14, controlling 64 control valve(s) 26 (26′, 26″) or conduit restrictor(s) 58 (58′, 58″) of at least one dynamic mixer 20 (20′, 20″) or Venturi aspirator 22, respectively, to control aspiration of drilling additive by the dynamic mixer 20 (20′, 20″), passing 66 the primary fluid and aspirated drilling additive through static mixer 28 to facilitate mixing, and discharging 68 the mixture of the primary and drilling additives to a borehole.

The method 60 typically includes the step of calculating 70 a desired mixture ratio (before or during mixing) of the primary and drilling additives according to a rate of aspiration of the drilling additive into said aspirator 22 in correlation with a rate of primary fluid supplied to the primary fluid inlet 14, as described above. The step of controlling 64 the control valve(s) 26 (26′, 26″) is generally performed to adjust the mixture concentration (relative proportions) of the primary and drilling additives.

Applicant believes it is particularly advantageous that some embodiments provide for an elegant and efficient solution in apparatus 10 that does not require electricity to facilitate optimal and accurately-controllable mixing of drilling additive with water to provide homogeneous solution that is not over-saturated. In particular, the embodiment of FIGS. 6A-6D allows flexibility in configuring a ratio of primary fluid to drilling additive which is particularly useful where apparatus 10 is used at various temperatures.

Variations

In any embodiment where an inlet, outlet, mixer, flow controller or the like is provided, it is possible for there to be multiple such instances to enable multiple different additives to be mixed and/or multiple different mix ratios.

The various alternative inlets, outlets, mixers and flow controller configurations of each embodiment could be combined in alternative manners.

As noted, a dynamic mixer has been shown, but is not necessarily physically bounded by a housing and the mixer could be considered any suitable combination components, including just the venturi aspirator on its own with a flow controller.

The entire apparatus itself might not have a housing but rather the individual components, but all can be considered part of a nominal apparatus. In this case, for example the static mixer and/or dynamic mixer might be separate components, each in their own housing, or not in a housing at all, linked by the required flow paths. The apparatus as a whole should not be considered limited by its physical arrangement.

Optional embodiments of the present embodiments may also be said to broadly consist in the parts, elements and features referred to or indicated herein, individually or collectively, in any or all combinations of two or more of the parts, elements or features, and wherein specific integers are mentioned herein which have known equivalents in the art to which the embodiments relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the embodiments, whilst other aspects are exemplified in a different example. These examples are intended to assist the skilled person in performing the embodiments and are not intended to limit the overall scope of the embodiments in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be figure understood that additional or alternative steps may be employed.

1. A dosing apparatus for mixing additive fluid with a primary fluid to prepare a drilling fluid at a drilling site for use in a downhole drilling operation, the apparatus being of a size and weight that can be disposed on, in or in the vicinity of a fluid vehicle, drilling apparatus and/or drilling site, the dosing apparatus comprising:
a dynamic mixer with at least a first primary fluid inlet, at least a first additive fluid inlet and at least a first drilling fluid outlet, the dynamic mixer configured to receive and combine primary fluid and additive fluid to prepare drilling fluid,
wherein the dynamic mixer is configured or configurable to control the ratio of primary fluid to additive fluid in the prepared drilling fluid.

2. A dosing apparatus for mixing additive fluid with a primary fluid to prepare a drilling fluid at a drilling site for use in a downhole drilling operation, the apparatus being of a size and weight that can be handled by a human and/or be disposed on a primary fluid vehicle or drilling apparatus, the dosing apparatus comprising:
a housing,
a dynamic mixer with at least a first primary fluid inlet, at least a first additive fluid inlet and at least a first drilling fluid outlet, the dynamic mixer configured to receive and combine primary fluid and additive fluid to prepare drilling fluid,
at least a first static mixer coupled to the dynamic mixer to receive and mix drilling fluid from the dynamic mixer,
wherein the dynamic mixer is configured or configurable to control the ratio of primary fluid to additive fluid in the prepared drilling fluid.

3. A dosing apparatus according to claim 1 wherein the dynamic mixer comprises:
a first venturi aspirator in fluid communication with the primary fluid inlet, additive fluid inlet and drilling fluid outlet,
at least a first flow controller for controlling primary fluid flow and/or additive fluid flow to control the ratio of primary fluid to additive fluid.

4. A dosing apparatus according to claim 3 wherein the flow controller comprises at least one control valve.

5. A dosing apparatus according to claim 3 wherein the flow controller comprises at least one conduit restrictor.

6. A dosing apparatus according to claim 3 further comprising a relief valve in communication with the primary fluid inlet upstream of the venturi aspirator.

7. A dosing apparatus according to claim 3 wherein the dynamic mixer comprises:
a primary fluid flow path fluidly communicating the primary fluid inlet to the drilling fluid outlet via the Venturi aspirator in communication with the first additive fluid inlet, and
a bypass fluid flow path fluidly communicating the primary fluid inlet to the drilling fluid outlet via the flow controller and bypassing the venturi aspirator.

8. A dosing apparatus according to claim 7 wherein the flow controller is a control valve that controls the aspiration of additive fluid to the primary fluid by control of the flow of fluid through the bypass fluid flow path.

9. A dosing apparatus according to claim 3 wherein the dynamic mixer comprises a second additive fluid inlet and a second flow controller and a second venturi aspirator, and wherein:
a first mixer fluid flow path fluidly communicating the primary fluid inlet to the drilling fluid outlet via the first flow controller and first venturi aspirator in fluid communication with the first additive fluid inlet,
a second mixer fluid flow path fluidly communicating the primary fluid inlet to the drilling fluid outlet via the second flow controller and second venturi aspirator in fluid communication with the second additive fluid inlet,
wherein the first and second flow controllers control the aspiration of additive fluid to the primary fluid by control of flow of fluid through the respective first and second fluid flow paths.

10. A dosing apparatus according to claim 9 further comprising a second drilling fluid outlet of the dynamic mixer and a second static mixer wherein the first static mixer is coupled to a first drilling fluid outlet of the first dynamic mixer and the second static mixer is coupled to a second drilling fluid outlet of the first dynamic mixer.

11. A dosing apparatus according to claim 3 comprising a second flow controller, and:
a first flow controller path fluidly communicating the additive fluid inlet to the venturi aspirator via the first flow controller,
a second flow controller path fluidly communicating the additive fluid inlet to the Venturi aspirator via the second flow controller,
wherein the first and second flow controllers are configured and/or selectable differently to control the aspiration of additive fluid to the primary fluid by control of flow of fluid through the respective first and second fluid flow paths.

12. A dosing apparatus according to claim 11 wherein the first and/or second flow controller is a control valve.

13. A dosing apparatus according to claim 11 wherein the first and/or second flow controller is a conduit restrictor.
